(19) United States
(12) Patent Application Publication
(10) Pub. No.: US 2022/0207379 A1
(43) Pub. Date: Jun. 30, 2022

(54) TEMPORAL KNOWLEDGE GRAPH COMPLETION METHOD AND APPARATUS BASED ON RECURSION

(71) Applicant: University of Posts & Telecommunications, Beijing (CN)

(72) Inventors: Haihong E, Beijing (CN); Meina Song, Beijing (CN); Youri XU, Beijing (CN)

(21) Appl. No.: 17/435,113

(22) PCT Filed: Dec. 28, 2020
(86) PCT No.: PCT/CN2020/140234

§ 371 Date: Aug. 31, 2021

(51) Int. Cl. G06N 5/02; G06N 3/08; G06F 16/901

(52) U.S. Cl. CPC G06N 5/022; G06F 16/9024; G06N 3/08

(57) ABSTRACT

The disclosure provides a temporal knowledge graph completion method, including: obtaining a temporal knowledge graph; obtaining a corresponding static knowledge graph, and obtaining an updated feature through performing embedding learning on a feature of the static knowledge graph and the static knowledge graph; starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning; determining the updated embedding learning parameter and the updated feature as an embedding learning parameter and a feature of a sub knowledge graph with an adjacent next timestamp, until all the sub knowledge graph sequences in the temporal knowledge graph are traversed; and performing fact prediction on each sub knowledge graph.

### CROSS-REFERENCE TO RELATED APPLICATIONS

This application is a U.S. national phase of International Application No. PCT/CN2020/140234, which claims priority to Chinese Patent Application No. 202010942741.7, filed on Sep. 9, 2020, the entire contents of which are incorporated herein by reference.

### TECHNICAL FIELD

The disclosure relates to the technical fields of information technology and data service, and in particular to a temporal knowledge graph completion method and apparatus based on recursion.

### BACKGROUND

Currently, factual relationship between users of social networks and e-commerce platforms changes over time (new entities and facts continue to appear). Therefore, the temporal knowledge graph obtained by extending the time dimension of a static knowledge graph has the potential to improve effects of question and answering, search and recommendation based on the knowledge graph. The facts of the temporal knowledge graph are distributed at respective timestamps, which reflects features of dynamic changes of entities and relationships over time. Since coverage scope of a knowledge graph is limited, the temporal knowledge graph also has the feature of incompleteness.

In the related art, a discrete event completion model and a continuous fact completion model are mainly used to complement a missing fact of a certain timestamp in the temporal knowledge graph. However, the discrete event completion model is an extension of a certain completion method for static knowledge graph, which lacks extensibility for completion of a new static knowledge graph. The continuous fact completion model trains facts of all timestamps at the same time. In practice, as new facts continue to appear, the temporal knowledge graph changes dynamically.

### SUMMARY

Embodiments of the disclosure provide a temporal knowledge graph completion method based on recursion. The method includes: obtaining a temporal knowledge graph, the temporal knowledge graph containing sub knowledge graph sequences with different timestamps; obtaining a static knowledge graph corresponding to the temporal knowledge graph, and obtaining an updated feature of the static knowledge graph through performing embedding learning on a feature of the static knowledge graph and the static knowledge graph, the updated feature of the static knowledge graph is a feature of a sub knowledge graph with a first timestamp; starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning, determining the updated embedding learning parameter as an embedding learning parameter of a sub knowledge graph with an adjacent next timestamp, and determining the updated feature as a feature of the sub knowledge graph with the adjacent next timestamp, until the sub knowledge graph sequences corresponding to all the timestamps in the temporal knowledge graph are traversed; and performing fact prediction on each sub knowledge graph in the temporal knowledge graph according to the embedding learning parameter and the feature corresponding to each sub knowledge graph to complement the temporal knowledge graph.

Embodiments of the disclosure provides a computer device including a memory, a processor, and a computer program stored on the memory and capable of running on the processor. When the processor executes the program, the temporal knowledge graph completion method based on recursion according to the first aspect of the embodiments of the disclosure is implemented.

Embodiments of the disclosure provides a non-transitory computer-readable storage medium storing computer instructions. When a processor executes the program, the temporal knowledge graph completion method based on recursion according to the first aspect of the embodiments of the disclosure is implemented.

Embodiments of the disclosure provides a computer program product, and when computer programs are executed by a processor, the temporal knowledge graph completion method based on recursion of the according to the first aspect of embodiments of the disclosure is implemented.

Additional aspects and advantages of embodiments of disclosure will be given in part in the following descriptions, become apparent in part from the following descriptions, or be learned from the practice of the embodiments of the disclosure.

### BRIEF DESCRIPTION OF THE DRAWINGS

The above and/or additional aspects and advantages of the disclosure will become apparent and more readily appreciated from the following descriptions made with reference to the accompanying drawings, in which:

FIG. 1 is a flowchart of a temporal knowledge graph completion method based on recursion according to an embodiment of the disclosure.

FIG. 2 is a schematic diagram of a temporal knowledge graph according to an embodiment of the disclosure.

FIG. 3 is a schematic diagram of missing facts in a temporal knowledge graph according to an embodiment of the disclosure.

FIG. 4 is a block diagram of a temporal knowledge graph completion apparatus based on recursion according to an embodiment of the disclosure.

### DETAILED DESCRIPTION

The embodiments of the disclosure are described in detail below. Examples of the embodiments are shown in the accompanying drawings, and the same or similar reference numerals indicate the same or similar elements or elements with the same or similar functions. The embodiments described below with reference to the drawings are exemplary, and are intended to explain the disclosure, but should not be understood as a limitation to the disclosure.

The following describes the temporal knowledge graph completion method and apparatus based on recursion according to embodiments of the disclosure with reference to the accompanying drawings. It should be noted that an execution subject of the method according to the embodiments of the disclosure is a temporal knowledge graph completion apparatus, and the above apparatus may be applied to any computer device to make the computer device perform a temporal knowledge graph completion function based on recursion. The computer device may be a personal computer (PC for short), a cloud device, a mobile device and a server. The mobile device may be hardware devices with various operating systems, touch screens and/or displays, such as, a mobile phone, a tablet computer, a personal digital assistant, a wearable device, a vehicle-mounted device.

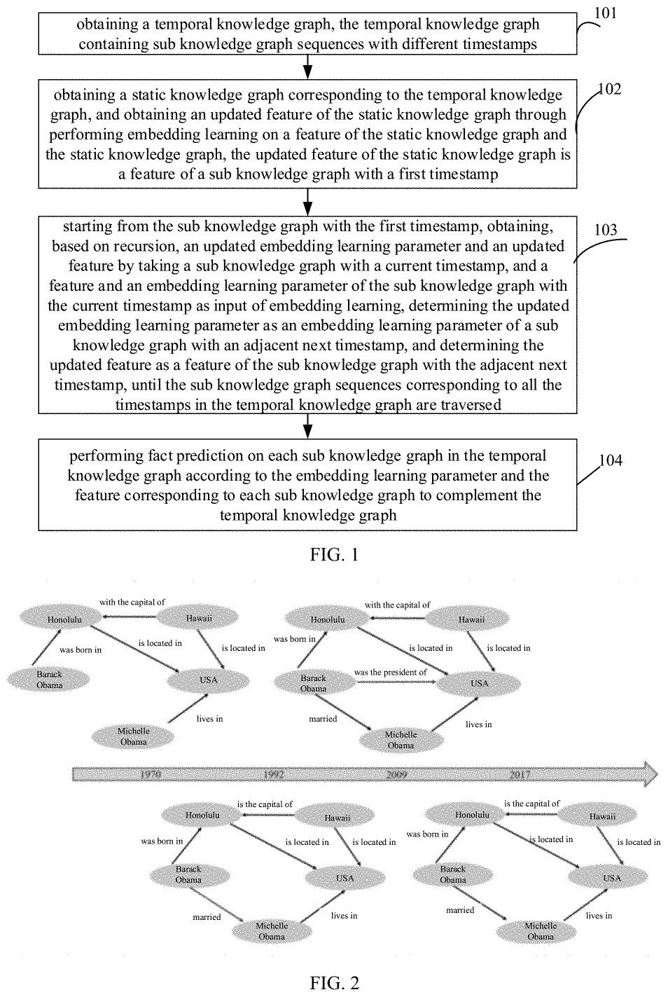

FIG. 1 is a flowchart of a temporal knowledge graph completion method based on recursion according to an embodiment of the disclosure.

As illustrated in FIG. 1, the temporal knowledge graph completion method based on recursion includes the followings.

At step 101, a temporal knowledge graph is obtained, the temporal knowledge graph contains sub knowledge graph sequences with different timestamps.

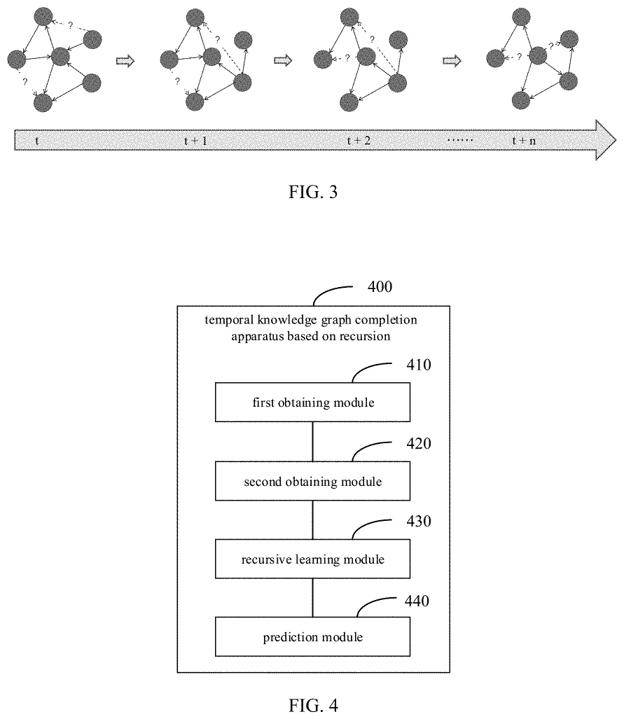

In an embodiment, as illustrated in FIG. 2, the temporal knowledge graph may be created by self-construction. The temporal knowledge graph is a knowledge graph with time attributes. Therefore, the temporal knowledge graph includes sub knowledge graph sequences with different timestamps. It should be noted that, in the self-construction process of the temporal knowledge graph, the relationship between entities is inevitably missing or a head entity or a tail entity of a relationship connection is missing, as illustrated in FIG. 3. Therefore, in an embodiment of the disclosure, the temporal knowledge graph may be a temporal knowledge graph with fact missing. A fact in a temporal knowledge graph may be one or more events last in a period of time.

At step 102, a static knowledge graph corresponding to the temporal knowledge graph is obtained, and an updated feature of the static knowledge graph is obtained through performing embedding learning on a feature of the static knowledge graph and the static knowledge graph, the updated feature of the static knowledge graph is a feature of a sub knowledge graph with a first timestamp.

Optionally, sub knowledge graph sequences Gₜ_{ᵢ} with different timestamps in the temporal knowledge graph G={Gₜ_{₁}, . . . , Gₜ_{ₙ}} is converted into a static knowledge graph G_{static}, and the static knowledge graph G_{static} is determined as the static knowledge graph corresponding to the temporal knowledge graph, and a specific expression equation being:

$${G}_{static} = {{⋃}_{i = 1}}^{n} {G}_{{t}_{i}} \qquad ( 1 )$$

where Gₜ_{ᵢ} represents a sub knowledge graph of the temporal knowledge graph at a time point tᵢ.

That is, facts of each sub knowledge graph sequence Gₜ_{ᵢ} in the temporal knowledge graph G={Gₜ_{₁}, . . . , Gₜ_{ₙ}} are combined into the same static knowledge graph G_{static}, and a specific expression equation being:

G_{static}={(s,r,o)|(s,r,o,tᵢ)ϵGₜ_{ᵢ},Gₜ_{ᵢ}ϵG} (2)

In an embodiment, after obtaining the static knowledge graph G_{static} corresponding to the temporal knowledge graph, feature extraction may be performed on the static knowledge graph, and a feature X corresponding to the static knowledge graph is obtained. Then, after performing the embedding learning on the static knowledge graph and the corresponding feature X to obtain the updated feature of the static knowledge graph. The updated feature of the static knowledge graph is determined as the feature of the sub knowledge graph with the first timestamp in the temporal knowledge graph. For example, the static knowledge graph and the corresponding feature X may be input into a static knowledge graph embedding learner, and the static knowledge graph embedding learner is configured to update the feature X, and output the updated feature X, and the updated feature X is determined as the feature of the sub knowledge graph with the first timestamp in the temporal knowledge graph.

At step 103, starting from the sub knowledge graph with the first timestamp, based on recursion, an updated embedding learning parameter and an updated feature are obtained by taking a sub knowledge graph with a current timestamp, and a feature and an embedding learning parameter of the sub knowledge graph with the current timestamp as input of embedding learning. The updated embedding learning parameter is determined as an embedding learning parameter of a sub knowledge graph with an adjacent next timestamp, and the updated feature is determined as a feature of the sub knowledge graph with the adjacent next timestamp, until the sub knowledge graph sequences corresponding to all the timestamps in the temporal knowledge graph are traversed.

It is understandable that, in the embodiments of the disclosure, the features of the sub knowledge graphs with different timestamps are updated, which is equivalent to providing one more channel for transmitting information between different timestamps. Therefore, in order to better performing embedding learning on the sub knowledge graph of the next timestamp, learner parameters of the static knowledge graph and the features of the sub knowledge graphs of different timestamps may be updated.

As an example, starting from the sub knowledge graph with the first timestamp, a loss function is constructed based on the sub knowledge graph with the current timestamp, and the feature and the embedding learning parameter of the sub knowledge graph with the current timestamp. The embedding learning parameter θₜ_{ᵢ} and the feature Xₜ_{ᵢ} are updated based on a gradient of the loss function.

For example, the static knowledge graph embedding learner is θ, the sub knowledge graph with the current timestamp is Gₜ_{ᵢ}, the embedding learning parameter corresponding to the sub knowledge graph with the current timestamp is θₜ_{ᵢ}, the feature of the sub knowledge graph with the current timestamp is X, thus the corresponding loss function is l(θₜ_{ᵢ}, X, Gₜ_{ᵢ}). Then, according to the gradient of the loss function, the embedding learning parameter θₜ_{ᵢ} and the feature Xₜ_{ᵢ} are updated. The specific equations are:

θₜ_{ᵢ}=θₜ_{ᵢ}−α [symbol] ∇_{θ}l(θₜ_{ᵢ},X,Gₜ_{ᵢ}) (3)

Xₜ_{ᵢ}=Xₜ_{ᵢ}−α∇_{X}l(θₜ_{ᵢ},X,Gₜ_{ᵢ}) (4)

Where α is a learning rate, ∇₀l(θₜ_{ᵢ}, X, Gₜ_{ᵢ}) and ∇_{X}l(θₜ_{ᵢ}, X, Gₜ_{ᵢ}) represent the gradients of the loss function. It should be noted that the embedding learning parameter corresponding to the sub knowledge graph with the first timestamp may be an initialized parameter of the static knowledge graph embedding learner.

Further, based on recursion, the updated embedding learning parameter θₜ_{ᵢ} is determined as an embedding learning parameter θₜ_{ᵢ₊₁} of the sub knowledge graph with the adjacent next timestamp, and the updated feature Xₜ_{ᵢ} is determined as a feature Xₜ_{ᵢ₊₁} of the sub knowledge graph with the adjacent next timestamp, with an equation of:

θₜ_{ᵢ₊₁}=θₜ_{ᵢ}, (5)

Xₜ_{ᵢ₊₁}=Xₜ_{ᵢ} (6).

It should be noted that embedding learning may include, but is not limited to, embedding learning based on translation ideas and embedding learning based on the neural network. The embedding learning based on translation ideas and the neural network may better analyze the static knowledge graph, which is conducive to the completion of the temporal knowledge graph. The embedding learning based on translation ideas may include but is not limited to algorithms such as TransE, TransD and RotatE, and the embedding learning based on neural network may include but is not limited to algorithms such as RGCN (Relational Graph Convolutional Network) and RDGCN (Relational Dual Graph Convolutional Network).

At step 104, fact prediction is performed on each sub knowledge graph in the temporal knowledge graph according to the embedding learning parameter and the feature corresponding to each sub knowledge graph to complement the temporal knowledge graph.

In order to better complement the temporal knowledge graph, in the embodiments of the disclosure, the fact prediction performed on the sub knowledge graph of each timestamp is divided into entity prediction and relationship prediction of knowledge graph. The entity prediction of the knowledge graph includes head entity prediction and tail entity prediction of the knowledge graph. For example, by using the embedding learning parameter and feature corresponding to the sub knowledge graph of each timestamp, the entity prediction and the relationship prediction of each sub knowledge graph is performed based on a probability that a quadruple of the sub knowledge graph of each timestamp is tenable.

For example, the sub knowledge graph sequence of the current timestamp is Gₜ_{ᵢ}, the embedding learning parameter corresponding to the sub knowledge graph of the current timestamp is θₜ_{ᵢ}, the feature of the sub knowledge graph of the current timestamp is Xₜ_{ᵢ}. In the head entity prediction (such as (?,r,o,tᵢ)), the head entity may be replaced with other entities s′, a loss function ∥Xₜ_{ᵢ}^{s′}+xₜ_{ᵢ}^{r}+Xₜ_{ᵢ}^{o}∥ of a corresponding quadruple under other entities may be calculated separately. The lower the value of the loss function, the more reliable the quadruple corresponding to the loss function is, and the more accurate the prediction effect is.

For example, the sub knowledge graph of the current timestamp is Gₜ_{ᵢ}, the embedding learning parameter corresponding to the sub knowledge graph of the current timestamp is θₜ_{ᵢ}, the feature of the sub knowledge graph of the current timestamp is Xₜ_{ᵢ}. In tail entity prediction (e.g., (s,r,?,tᵢ)), the tail entity may be replaced with other entities o′, a loss function ∥Xₜ_{ᵢ}^{s}+Xₜ_{ᵢ}^{r}++Xₜ_{ᵢ}^{o′}∥ of the corresponding quadruple under other entities may be calculated separately. The lower the value of the loss function, the more reliable the quadruple corresponding to the loss function is, and the more accurate the prediction effect is.

For example, the sub knowledge graph of the current timestamp is Gₜ_{ᵢ}, the embedding learning parameter corresponding to the sub knowledge graph of the current timestamp is θₜ_{ᵢ}, and the feature of the sub knowledge graph of the current timestamp is Xₜ_{ᵢ}. In the relationship prediction (e.g., (s,?,o,tᵢ)), the relationship may be replaced with other relationships r′, a loss function ∥Xₜ_{ᵢ}^{s}+Xₜ_{ᵢ}^{r′}++Xₜ_{ᵢ}^{o}∥ of the corresponding quadruple under other relationships may be calculated separately. The lower the value of the loss function, the more reliable the quadruple corresponding to the loss function is, and the more accurate the prediction effect is.

In conclusion, based on recursion, the embedding learning is performed on the temporal knowledge graph timestamp by timestamp. Meanwhile, by using the information of the knowledge graph of the previous timestamp, it is naturally extended to the knowledge graph of a future timestamp to perform fact completion, without the need to retrain the entire model due to appearance of a knowledge graph with a new timestamp, which is extensible.

In order to better analyze the static knowledge graph and to facilitate the completion of the temporal knowledge graph, in the embodiments of the disclosure, the static knowledge graph may be analyzed based on the embedding learning based on translation ideas and neural network. The embedding learning based on translation ideas may include but is not limited to algorithms such as TransE, TransD, RotatE, and the embedding learning based on neural network may include but is not limited to algorithms such as RGCN and RDGCN.

For the embedding learning algorithm TransE based on translation ideas, a triplet is (s, r, o), the relationship r is determined as a translation from the head entity to the tail entity o in TransE, and an expected reserved space of the positive triplet (s, r, o) in the embedding space is eₛ+eᵣ≈eₒ. Therefore, the loss function for measuring the reliability of the triplet may be:

f(s,r,o)=∥eₛ+eᵣ−eₒ∥ (7)

It should be understood that a loss function of a real triplet corresponds to a lower loss value, while a loss function of a false triplet corresponds to a higher loss value. In order to make the loss functions of the positive and negative triplets distinguishable, TransE uses a difference-based objective function, the specific equation is:

$$L = {\sum }_{( s , r , o ) ∈ S} {\sum }_{( {s}^{′} , {r}^{′} , {o}^{′} ) ∈ {S}^{′}} max ( 0 , γ + f ( s , r , o ) - f ( {s}^{′} , {r}^{′} , {o}^{′} ) ) \qquad ( 8 )$$

Where, S represents a set of positive triples, S′ represents a set of negative triples, γ represents a hyper-parameter that controls discrimination between the loss functions of positive and negative triples, f(s, r, o) represents a loss function corresponding to a positive triple, and f(s′,r′,o′) represents a loss function corresponding to a negative triple. It should also be noted that, the TransE algorithm just uses the features of the knowledge graph but does not use other parameters. Therefore, in the embodiments of the disclosure, when using the embedding learning of TransE algorithm based on translation ideas, the features of the sub knowledge graphs with different timestamps are updated and transferred according to above equations (4) and (6).

For the embedding learning of TransD algorithm based on the translation idea, the entities and relationships of the sub knowledge graphs with different timestamps may be projected to a hyper-plane, so that the projections of the entities and the relationships on the hyper-plane are close to each other. Since a head entity h and a tail entity t may be different types of entities, TransD uses different mapping matrices for the head entity and the tail entity. The mapping matrixs are determined by both the entities and the relationships. The mapping matrix corresponding to the head entity may be expressed as Mᵣₕ=rₚhₚ^{T}+I^{m×n}, and the mapping matrix corresponding to the tail entity may be expressed as Mᵣₜ=rₚtₚ^{T}+I^{m×n}, Where rₚ represents a projection vector of the relationship r, hₚ^{T} represents transposition of a projection vector of the head entity h, and I^{m×n} represents an m×n matrix with diagonal elements being l and other elements being 0, tₚ^{T} represents transposition of a projection vector of the tail entity t. In a space after the projection, it is expected to maintain a distance function ∥Mᵣₕh+r−Mᵣₜt∥ based on translation. It should be noted that, comparing with the TransE algorithm, the TransD algorithm uses a projection matrix. Therefore, when using the embedding learning TransD algorithm based on translation ideas, in addition to updating and transferring the features of the sub knowledge graphs with different timestamps according to equations (4) and (6), the embedding learning parameters (namely the projection matrix M) are updated and transferred according to equations (3) and (5).

For the embedding learning RotatE algorithm based on translation ideas, the algorithm can simultaneously model symmetric, antisymmetric, reversible, and combinatorial relationship patterns. Inspired by Euler's formula e^{iθ}=cos θ+i sin θ, the RotatE algorithm defines the relationships between the sub knowledge graphs with different timestamps in a complex vector space, rotation from the head entity to the tail entity. For example, embedding of a triplet (h, r, t) is expected to satisfy h∘r=t, where ∘ is a Hadamard product (multiplied element-by-element), and a distance function is defined as ∥h∘r−t∥. The RotatE algorithm just uses the features of the knowledge graph but does not use other parameters. Therefore, in the embodiments of the disclosure, when using the RotatE algorithm for embedding learning based on translation ideas, the features of the sub knowledge graphs with different timestamps may be updated and transferred according to equations (4) and (6).

For the embedding learning RGCN algorithm based on the neural network, the RGCN algorithm uses a graph convolutional network for embedding learning of the sub knowledge graphs with different timestamps. In detail, graph convolutional network nodes are updated layer by layer with the following equation:

$${h}_{i}^{( l + 1 )} = σ ( {Σ}_{r ∈ R} {Σ}_{j ∈ {N}_{i}^{T}} \frac{1}{{c}_{i , r}} {W}_{r}^{( l )} {h}_{j}^{( l )} + {W}_{o}^{( l )} {h}_{j}^{( l )} ) \qquad ( 9 )$$

Where, σ represents an activation function RELU(⋅)=max(0,⋅), R represents a relationship set of the knowledge graph, r represents a relationship, Nᵢ^{r} represents a set of nodes connected to the node i through the relationship r, j represents a node, c_{i,r} represents a normalization constant, which is set as c_{i,r}=|Nᵢ^{r}|, Wᵣ^{(l)} represents a mapping matrix of the relationship r in the l^{th} layer, Wₒ^{(l)} represents a mapping matrix of nodes in the l^{th} layer, hⱼ^{(l)} represents the feature of the node j in the l^{th} layer, and hᵢ^{(l+1)} represents the feature of the node i in the (l+1)^{th} layer.

It should be noted that the input feature h^{(o)} may be updated and transferred according to equations (4) and (6), and the parameter W may be updated and transferred according to equations (3) and (5).

For the embedding learning RDGCN algorithm based on neural network, the RDGCN algorithm is a graph convolutional network model that learns relationships and structural information with the help of an attention interaction mechanism between original graphs and dual graphs. The algorithm first fixes a relational dual graph, which is regarded as a semantic graph between relationships, and allows the original graph (sub knowledge graphs with different timestamps) to change over time, so as to capture changes of the relationship between the entities without changing the relational semantics. After obtaining an entity representation X̅^{E}ϵR^{|V|×d} and a relationship representation X̅^{R}ϵR^{|V|×2d} output by the graph convolutional network, a reliability of a triplet (s, r, o) may be determined and expressed by a function composed of a type distance and a semantic distance as follows:

d(s,r,o)=d_{types}(s,r,o)+λ [symbol] d_{semantic}(s,r,o) (10)

d_{types}(s,r,o)=∥[x̅ₛ^{E};x̅ₒ^{E}]−x̅ᵣ^{R}∥ (11)

d_{semantic}(s,r,o)=∥([x̅ₛ^{E};x̅ₒ^{E}]−x̅ᵣ^{R})[:d]−([x̅ₛ^{E};x̅ₒ^{E}]−x̅ᵣ^{R})[d:]∥ (12)

Where, d_{types}(s,r,o) represents the type distance, d_{semantic}(s,r,o) represents the semantic distance, λ represents a weight of the semantic distance, x̅ₛ^{E} represents a feature vector of an output entity s, x̅ₒ^{E} represents a feature vector of an output entity o, x̅ᵣ^{R} represents a feature vector of an output relationship r, and d represents a dimension of the entity output vector.

It should be noted that the type distance may be used to measure a legitimacy of a triple type. For example, a triple (New Orleans, located at, USA) is a triple of a correct type, and a triple (New Orleans, located at, Obama) is a triple of a wrong type. The smaller the type distance, the greater the correctness of the type of the corresponding triple is. For the correct type of triples, the semantic distance is used to further distinguish the semantics of the triples. For example, for the triple (New Orleans, located at, USA) and the triple (New Orleans, located at, UK), the semantic distance between “New Orleans” and “USA” is greater than the semantic distance between “New Orleans” and “UK”. The smaller the semantic distance, the greater the semantic correctness of the triplet is.

In conclusion, the static knowledge graph may be analyzed based on the embedding learning based on translation ideas and neural network, and applying the static knowledge graph analysis method to the temporal knowledge graph is conducive to the completion of the temporal knowledge graph.

With the temporal knowledge graph completion method based on recursion according to embodiments of the disclosure, the temporal knowledge graph is obtained, the temporal knowledge graph contains sub knowledge graph sequences with different timestamps. The static knowledge graph corresponding to the temporal knowledge graph is obtained, and an updated feature of the static knowledge graph is obtained through performing embedding learning on the feature of the static knowledge graph and the static knowledge graph. The updated feature of the static knowledge graph is the feature of the sub knowledge graph with the first timestamp. Starting from the sub knowledge graph with the first timestamp, based on recursion, an updated embedding learning parameter and an updated feature are obtained by taking a sub knowledge graph with a current timestamp, and a feature and an embedding learning parameter of the sub knowledge graph with the current timestamp as input of embedding learning. The updated embedding learning parameter is determined as an embedding learning parameter of a sub knowledge graph with an adjacent next timestamp, and the updated feature is determined as a feature of the sub knowledge graph with the adjacent next timestamp, until the sub knowledge graph sequences corresponding to all the timestamps in the temporal knowledge graph are traversed. Fact prediction is performed on each sub knowledge graph in the temporal knowledge graph according to the embedding learning parameter and the feature corresponding to each sub knowledge graph to complement the temporal knowledge graph. With this method, the embedding learning is performed on the temporal knowledge graph based on recursion timestamp by timestamp. Meanwhile, by using the information of the knowledge graph of the previous timestamp, it is naturally extended to the knowledge graph of a future timestamp to perform fact completion, without the need to retrain the entire model due to appearance of a knowledge graph with a new timestamp, which is extensible.

In order to implement the above embodiments, the disclosure further provides a temporal knowledge graph completion apparatus based on recursion.

FIG. 4 is a block diagram of a temporal knowledge graph completion apparatus based on recursion according to an embodiment of the disclosure.

As illustrated in FIG. 4, the temporal knowledge graph completion apparatus 400 based on recursion includes: a first obtaining module 410, a second obtaining module 420, a recursive learning module 430 and a prediction module 440.

The first obtaining module 410 is configured to obtain a temporal knowledge graph, the temporal knowledge graph containing sub knowledge graph sequences with different timestamps. The second obtaining module 420 is configured to obtain a static knowledge graph corresponding to the temporal knowledge graph, and obtain an updated feature of the static knowledge graph through performing embedding learning on a feature of the static knowledge graph and the static knowledge graph, the updated feature of the static knowledge graph is a feature of a sub knowledge graph with the first timestamp. The recursive learning module 430 is configured to, starting from the sub knowledge graph with the first timestamp, obtain, based on recursion, an updated embedding learning parameter and an updated feature by taking a sub knowledge graph with a current timestamp, and a feature and an embedding learning parameter of the sub knowledge graph with the current timestamp as input of embedding learning, determine the updated embedding learning parameter as an embedding learning parameter of a sub knowledge graph with an adjacent next timestamp, and determine the updated feature as a feature of the sub knowledge graph with the adjacent next timestamp, until the sub knowledge graph sequences corresponding to all the timestamps in the temporal knowledge graph are traversed. The prediction module 440 is configured to perform fact prediction on each sub knowledge graph in the temporal knowledge graph according to the embedding learning parameter and the feature corresponding to the sub knowledge graph to complement the temporal knowledge graph.

In a possible implementation of the embodiments of the disclosure, the embedding learning includes: embedding learning based on translation ideas and a neural network.

In a possible implementation of the embodiments of the disclosure, the second obtaining module 420 is configured to: convert sub knowledge graph sequences Gₜ_{ᵢ} with different timestamps in the temporal knowledge graph G={Gₜ_{₁}, . . . , Gₜ_{ₙ}} to a static knowledge graph G_{static}, and determine the static knowledge graph G_{static} as the static knowledge graph corresponding to the temporal knowledge graph, and a specific expression equation being:

$${G}_{static} = {{⋃}_{i = 1}}^{n} {G}_{{t}_{i}} ,$$

where Gₜ_{ᵢ} represents a sub knowledge graph of the temporal knowledge graph at a time point tᵢ.

In a possible implementation of the embodiments of the disclosure, the recursive learning module 430 is configured to:

construct, starting from the sub knowledge graph with the first timestamp, a loss function based on the sub knowledge graph with the current timestamp, the feature and the embedding learning parameter of the sub knowledge graph with the current timestamp;

update the embedding learning parameter θₜ_{ᵢ} and the feature Xₜ_{ᵢ} based on a gradient of the loss function according to a specific equation as:

θₜ_{ᵢ}=θₜ_{ᵢ}−α [symbol] ∇_{θ}l(θₜ_{ᵢ},X,Gₜ_{ᵢ}),

Xₜ_{ᵢ}=Xₜ_{ᵢ}−α·∇_{X}l(θₜ_{ᵢ},X,Gₜ_{ᵢ}),

where α is a learning rate, ∇_{θ}l(θₜ_{ᵢ},X, Gₜ_{ᵢ}) and ∇_{X}l(θₜ_{ᵢ}, X, Gₜ_{ᵢ}) represent the gradient of the loss function; and

determine the updated embedding learning parameter θₜ_{ᵢ} as an embedding learning parameter θₜ_{ᵢ₊₁} of the sub knowledge graph with the adjacent next timestamp, and determining the updated feature Xₜ_{ᵢ} as a feature Xₜ_{ᵢ₊₁} of the sub knowledge graph with the adjacent next timestamp, with an equation of:

θₜ_{ᵢ₊₁}=θₜ_{ᵢ},

Xₜ_{ᵢ₊₁}=Xₜ_{ᵢ}.

With the temporal knowledge graph completion apparatus based on recursion according to embodiments of the disclosure, the temporal knowledge graph is obtained, the temporal knowledge graph contains sub knowledge graph sequences with different timestamps. The static knowledge graph corresponding to the temporal knowledge graph is obtained, and an updated feature of the static knowledge graph is obtained through performing embedding learning on the feature of the static knowledge graph and the static knowledge graph. The updated feature of the static knowledge graph is the feature of the sub knowledge graph with the first timestamp. Starting from the sub knowledge graph with the first timestamp, based on recursion, an updated embedding learning parameter and an updated feature are obtained by taking a sub knowledge graph with a current timestamp, and a feature and an embedding learning parameter of the sub knowledge graph with the current timestamp as input of embedding learning. The updated embedding learning parameter is determined as an embedding learning parameter of a sub knowledge graph with an adjacent next timestamp, and the updated feature is determined as a feature of the sub knowledge graph with the adjacent next timestamp, until the sub knowledge graph sequences corresponding to all the timestamps in the temporal knowledge graph are traversed. Fact prediction is performed on each sub knowledge graph in the temporal knowledge graph according to the embedding learning parameter and the feature corresponding to each sub knowledge graph to complement the temporal knowledge graph. The apparatus may implement embedding learning on the temporal knowledge graph based on recursion timestamp by timestamp. Meanwhile, by using the information of the knowledge graph of the previous timestamp, it is naturally extended to the knowledge graph of a future timestamp to perform fact completion, without the need to retrain the entire model due to appearance of a knowledge graph with a new timestamp, which is extensible.

In order to achieve the above embodiments, the disclosure further includes a computer device including a memory, a processor, and a computer program stored on the memory and capable of running on the processor. When the processor executes the program, the temporal knowledge graph completion method based on recursion according to the foregoing embodiments of the disclosure is implemented.

In order to achieve the above embodiments, the disclosure further includes a non-transitory computer-readable storage medium storing computer programs. When a processor executes the program, the temporal knowledge graph completion method based on recursion according to the foregoing embodiments of the disclosure is implemented.

In order to achieve the above embodiments, the disclosure further includes a computer program product, and when computer programs are executed by a processor, the temporal knowledge graph completion method based on recursion according to the foregoing embodiments of the disclosure is implemented.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the disclosure. The appearances of the above phrases in various places throughout this specification are not necessarily referring to the same embodiment or example of the disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance. Thus, the feature defined with “first” and “second” may explicitly or implicitly include at least one of those features. In the description of the disclosure, “a plurality of” means at least two, for example, two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the disclosure includes other implementations, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be implemented by instructing related hardware via programs. The program may be stored in a computer readable storage medium. When the program is executed, the program includes one step or combinations of the steps of the method when the program is executed.

In addition, individual functional units in the embodiments of the disclosure may be integrated in one processing module or may physically exist as an independent unit, or two or more units may be integrated in one module. The integrated module as described above may be embodied in the form of hardware, or may be embodied in the form of a software functional module. If the integrated module is embodied in the form of a software functional module and sold or used as an independent product, the integrated module may also be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the disclosure, and changes, alternatives, and modifications can be made in the embodiments without departing from scope of the disclosure.

1. A temporal knowledge graph completion method based on recursion, comprising:
obtaining a temporal knowledge graph, the temporal knowledge graph containing sub knowledge graph sequences with different timestamps;
obtaining a static knowledge graph corresponding to the temporal knowledge graph, and obtaining an updated feature of the static knowledge graph through performing embedding learning on a feature of the static knowledge graph and the static knowledge graph, wherein the updated feature of the static knowledge graph is a feature of a sub knowledge graph with a first timestamp;
starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning, determining the updated embedding learning parameter as an embedding learning parameter of a sub knowledge graph with an adjacent next timestamp, and determining the updated feature as a feature of the sub knowledge graph with the adjacent next timestamp, until the sub knowledge graph sequences corresponding to all the timestamps in the temporal knowledge graph are traversed; and
performing fact prediction on each sub knowledge graph in the temporal knowledge graph according to the embedding learning parameter and the feature corresponding to each sub knowledge graph to complement the temporal knowledge graph.

2. The method of claim 1, wherein the embedding learning comprises embedding learning based on translation ideas and a neural network.

3. The method of claim 1, wherein obtaining the static knowledge graph corresponding to the temporal knowledge graph comprises:
converting sub knowledge graph sequences Gₜ_{ᵢ} with different timestamps in the temporal knowledge graph G={Gₜ_{₁}, . . . , Gₜ_{ₙ}} into a static knowledge graph G_{static}, and determining the static knowledge graph G_{static} as the static knowledge graph corresponding to the temporal knowledge graph, and a specific expression equation being:
$${G}_{static} = {{⋃}_{i = 1}}^{n} {G}_{{t}_{i}} ,$$
where Gₜ_{ᵢ} represents a sub knowledge graph of the temporal knowledge graph at a time point tᵢ.

4. The method of claim 1, wherein, starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning, comprises:
starting from the sub knowledge graph with the first timestamp, constructing a loss function based on the sub knowledge graph with the current timestamp, and the feature and the embedding learning parameter of the sub knowledge graph with the current timestamp;
updating the embedding learning parameter θₜ_{ᵢ} and the feature Xₜ_{ᵢ} based on a gradient of the loss function according to a specific equation as:
θₜ_{ᵢ}=θₜ_{ᵢ}−α [symbol] ∇_{θ}l(θₜ_{ᵢ},X,Gₜ_{ᵢ}),
Xₜ_{ᵢ}=Xₜ_{ᵢ}−α·∇_{X}l(θₜ_{ᵢ},X,Gₜ_{ᵢ}),
where α is a learning rate, ∇_{θ}l(θₜ_{ᵢ}, X, Gₜ_{ᵢ}) and ∇_{X}l(θₜ_{ᵢ}, X, Gₜ_{ᵢ}) represent the gradients of the loss function; and
determining the updated embedding learning parameter θₜ_{ᵢ} as an embedding learning parameter θₜ_{ᵢ₊₁} of the sub knowledge graph with the adjacent next timestamp, and determining the updated feature Xₜ_{ᵢ} as a feature Xₜ_{ᵢ₊₁} of the sub knowledge graph with the adjacent next timestamp, with an equation of:
θₜ_{ᵢ₊₁}=θₜ_{ᵢ},
Xₜ_{ᵢ₊₁}=Xₜ_{ᵢ}.

5.-8. (canceled)

9. A computer device, comprising:
a memory;
a processor; and
a computer program stored on the memory and capable of running on the processor;
wherein, when the processor executes the program, a temporal knowledge graph completion method based on recursion is performed, the method comprising:
obtaining a temporal knowledge graph, the temporal knowledge graph containing sub knowledge graph sequences with different timestamps;
obtaining a static knowledge graph corresponding to the temporal knowledge graph, and obtaining an updated feature of the static knowledge graph through performing embedding learning on a feature of the static knowledge graph and the static knowledge graph, wherein the updated feature of the static knowledge graph is a feature of a sub knowledge graph with a first timestamp;
starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning, determining the updated embedding learning parameter as an embedding learning parameter of a sub knowledge graph with an adjacent next timestamp, and determining the updated feature as a feature of the sub knowledge graph with the adjacent next timestamp, until the sub knowledge graph sequences corresponding to all the timestamps in the temporal knowledge graph are traversed; and
performing fact prediction on each sub knowledge graph in the temporal knowledge graph according to the embedding learning parameter and the feature corresponding to each sub knowledge graph to complement the temporal knowledge graph.

10. The computer device of claim 9, wherein the embedding learning comprises embedding learning based on translation ideas and a neural network.

11. The computer device of claim 9, wherein obtaining the static knowledge graph corresponding to the temporal knowledge graph comprises:
converting sub knowledge graph sequences Gₜ_{ᵢ} with different timestamps in the temporal knowledge graph G={Gₜ_{₁}, . . . , Gₜ_{ₙ}} into a static knowledge graph G_{static}, and
determining the static knowledge graph G_{static} as the static knowledge graph corresponding to the temporal knowledge graph, and a specific expression equation being:
$${G}_{static} = {{⋃}_{i = 1}}^{n} {G}_{{t}_{i}} ,$$
where Gₜ_{ᵢ} represents a sub knowledge graph of the temporal knowledge graph at a time point tᵢ.

12. The computer device of claim 9, wherein, starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning, comprises:
starting from the sub knowledge graph with the first timestamp, constructing a loss function based on the sub knowledge graph with the current timestamp, and the feature and the embedding learning parameter of the sub knowledge graph with the current timestamp;
updating the embedding learning parameter θₜ_{ᵢ} and the feature Xₜ_{ᵢ} based on a gradient of the loss function according to a specific equation as:
θₜ_{ᵢ}=θₜ_{ᵢ}−α [symbol] ∇_{θ}l(θₜ_{ᵢ},X,Gₜ_{ᵢ}),
Xₜ_{ᵢ}=Xₜ_{ᵢ}−α·∇_{X}l(θₜ_{ᵢ},X,Gₜ_{ᵢ}),
where α is a learning rate, ∇_{θ}l(θₜ_{ᵢ}, X, Gₜ_{ᵢ}) and ∇_{X}l(θₜ_{ᵢ}, X, Gₜ_{ᵢ}) represent the gradients of the loss function; and
determining the updated embedding learning parameter θₜ_{ᵢ} as an embedding learning parameter θₜ_{ᵢ₊₁} of the sub knowledge graph with the adjacent next timestamp, and determining the updated feature Xₜ_{ᵢ} as a feature Xₜ_{ᵢ₊₁} of the sub knowledge graph with the adjacent next timestamp, with an equation of:
θₜ_{ᵢ₊₁}=θₜ_{ᵢ},
Xₜ_{ᵢ₊₁}=Xₜ_{ᵢ}.

13. A non-transitory computer-readable storage medium, comprising:
a memory;
a processor; and
a computer program stored on the memory and capable of running on the processor;
wherein, when the processor executes the program, a temporal knowledge graph completion method based on recursion is performed, the method comprising:
obtaining a temporal knowledge graph, the temporal knowledge graph containing sub knowledge graph sequences with different timestamps;
obtaining a static knowledge graph corresponding to the temporal knowledge graph, and obtaining an updated feature of the static knowledge graph through performing embedding learning on a feature of the static knowledge graph and the static knowledge graph, wherein the updated feature of the static knowledge graph is a feature of a sub knowledge graph with a first timestamp;
starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning, determining the updated embedding learning parameter as an embedding learning parameter of a sub knowledge graph with an adjacent next timestamp, and determining the updated feature as a feature of the sub knowledge graph with the adjacent next timestamp, until the sub knowledge graph sequences corresponding to all the timestamps in the temporal knowledge graph are traversed; and
performing fact prediction on each sub knowledge graph in the temporal knowledge graph according to the embedding learning parameter and the feature corresponding to each sub knowledge graph to complement the temporal knowledge graph.

14. The storage medium of claim 13, wherein the embedding learning comprises embedding learning based on translation ideas and a neural network.

15. The storage medium of claim 13, wherein obtaining the static knowledge graph corresponding to the temporal knowledge graph comprises:
converting sub knowledge graph sequences Gₜ_{ᵢ} with different timestamps in the temporal knowledge graph G={Gₜ_{₁}, . . . , Gₜ_{ₙ}} into a static knowledge graph G_{static}, and determining the static knowledge graph G_{static} as the static knowledge graph corresponding to the temporal knowledge graph, and a specific expression equation being:
$${G}_{static} = {{⋃}_{i = 1}}^{n} {G}_{{t}_{i}} ,$$
where Gₜ_{ᵢ} represents a sub knowledge graph of the temporal knowledge graph at a time point tᵢ.

16. The storage medium of claim 13, wherein, starting from the sub knowledge graph with the first timestamp, obtaining, based on recursion, an updated embedding learning parameter and an updated feature by taking a sub knowledge graph with a current timestamp, and a feature and an embedding learning parameter of the sub knowledge graph with the current timestamp as input of embedding learning, comprises:
starting from the sub knowledge graph with the first timestamp, constructing a loss function based on the sub knowledge graph with the current timestamp, and the feature and the embedding learning parameter of the sub knowledge graph with the current timestamp;
updating the embedding learning parameter θₜ_{ᵢ} and the feature Xₜ_{ᵢ} based on a gradient of the loss function according to a specific equation as:
θₜ_{ᵢ}=θₜ_{ᵢ}−α [symbol] ∇_{θ}l(θₜ_{ᵢ},X,Gₜ_{ᵢ}),
Xₜ_{ᵢ}=Xₜ_{ᵢ}−α·∇_{X}l(θₜ_{ᵢ},X,Gₜ_{ᵢ}),
where α is a learning rate, ∇_{θ}l(θₜ_{ᵢ}, X, Gₜ_{ᵢ}) and ∇_{X}l(θₜ_{ᵢ}, X, Gₜ_{ᵢ}) represent the gradients of the loss function; and
determining the updated embedding learning parameter θₜ_{ᵢ} as an embedding learning parameter θₜ_{ᵢ₊₁} of the sub knowledge graph with the adjacent next timestamp, and determining the updated feature Xₜ_{ᵢ} as a feature Xₜ_{ᵢ₊₁} of the sub knowledge graph with the adjacent next timestamp, with an equation of:
θₜ_{ᵢ₊₁}=θₜ_{ᵢ},
Xₜ_{ᵢ₊₁}=Xₜ_{ᵢ}.
